(19) United States
(12) Patent Application Publication
(10) Pub. No.: US 2023/0202327 A1
(43) Pub. Date: Jun. 29, 2023

(54) ELECTRIC VEHICLE HYBRID CHARGING SYSTEM

(71) Applicants: Siddharth Suhas Kulkarni, Birmingham (GB); Akanksha Vyas, Birmingham (GB); Reena Singh, Maharashtra (IN)

(72) Inventors: Siddharth Suhas Kulkarni, Birmingham (GB); Akanksha Vyas, Birmingham (GB); Reena Singh, Maharashtra (IN)

(21) Appl. No.: 18/175,931

(22) Filed: Feb. 28, 2023

(51) Int. Cl. B60L 53/55; B60L 58/18

(52) U.S. Cl. CPC B60L 53/55; B60L 58/18; B60L 2210/40

(57) ABSTRACT

The present invention generally relates to an electric vehicle hybrid charging system comprises first bank and a second bank of series connected switches an interconnected in between an input voltage terminal and a reference voltage terminal in a series connection; a plurality of switched capacitors (SCs) having a first terminal interconnected between two adjacent switches of the first bank and a second capacitor terminal interconnected between two adjacent switches of the second bank; and a controller having a first frequency by controlling the plurality of switch pairs such that each switch pair is switched at staggered times relating to other plurality of switch pairs during a periodic switching cycle, wherein each switch pair consists of a switch from the first bank and a switch from the second bank, and the periodic switching cycle has a second frequency that is higher than the first frequency.

### FIELD OF THE INVENTION

The present disclosure relates to an electric vehicle hybrid charging system, more specifically, the system is used to provide electricity to electric automobile and to develop switched capacitor (SC) based high move forward staggered inverter with self-adjusting ability.

### BACKGROUND OF THE INVENTION

Now-a-days electrically powered vehicle is developing in all over the world, because on electric vehicle a power storage device is mounted for advancement in these vehicles. There are vehicles (electric vehicles, plug-in hybrid vehicles, and the like) configured such that a power storage device can be charged with electric power supplied from a charging device provided outside the vehicle.

In one prior art solution(US10442301B2), a method of charging an electric vehicle at a charging station. The charging station is configured to charge the vehicle using a charging station charge protocol and the vehicle is configured to receive the charge using a vehicle charge protocol.

In second prior art solution(US11413982B2), a system for controlling a plurality of mobile electric vehicle charging platforms. The mobile electric vehicle system comprises a communications interface for transmitting and receiving the control data between the at least one central server implementing the mobile electric vehicle charging system, the plurality of mobile charging platforms and the electric vehicle. A database stores mobile charging platform data and electric vehicle data.

In the view of the forgoing discussion, it is clearly portrayed that there is a need to have an electric vehicle hybrid charging system.

### SUMMARY OF THE INVENTION

The present disclosure seeks to provide a user-friendly electric vehicle hybrid charging system to create and handle Electric Vehicles (EV) charging procedures, based on intelligent process.

In an embodiment, an electric vehicle hybrid charging system is disclosed. The system includes a first bank and a second bank of series connected switches interconnected in between an input voltage terminal and a reference voltage terminal in a series connection. The system further includes a plurality of switched capacitors (SCs) having a first terminal interconnected between two adjacent switches of the first bank and a second capacitor terminal interconnected between two adjacent switches of the second bank. The system further includes a controller having a first frequency by controlling the plurality of switch pairs such that each switch pair is switched at staggered times relating to other plurality of switch pairs during a periodic switching cycle, wherein each switch pair consists of a switch from the first bank and a switch from the second bank, and the periodic switching cycle has a second frequency that is higher than the first frequency.

An object of the present disclosure is to replenish the battery of an electric vehicle in order to keep it moving.

Another object of the present disclosure is to the design of a system to create and handle Electric Vehicles (EV) charging procedures, based on intelligent process.

Yet another object of the present invention is to deliver an expeditious and cost-effective electric vehicle hybrid charging system.

To further clarify advantages and features of the present disclosure, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF FIGURES

These and other features, aspects, and advantages of the present disclosure will become better understood when the following detailed description is read with reference to the accompanying drawings in which like characters represent like parts throughout the drawings, wherein:

FIG. 1 illustrates a block diagram of an electric vehicle hybrid charging system in accordance with an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises...a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

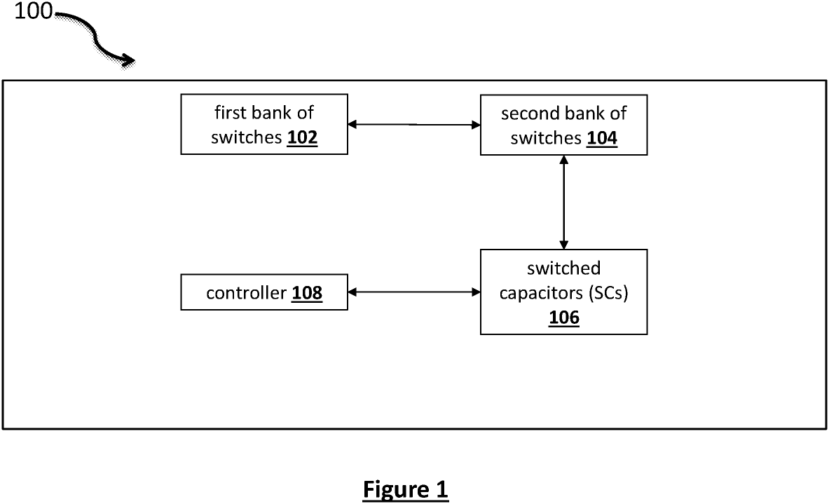

Referring to FIG. 1, a block diagram of an electric vehicle hybrid charging system is illustrated in accordance with an embodiment of the present disclosure. The system 100 includes first bank 102 and a second bank 104 of series connected switches an interconnected in between an input voltage terminal and a reference voltage terminal in a series connection.

In an embodiment, a plurality of switched capacitors (SCs) 106 having a first terminal interconnected between two adjacent switches of the first bank and a second capacitor terminal interconnected between two adjacent switches of the second bank.

In an embodiment, a controller 108 having a first frequency by controlling the plurality of switch pairs such that each switch pair is switched at staggered times relating to other plurality of switch pairs during a periodic switching cycle, wherein each switch pair consists of a switch from the first bank and a switch from the second bank, and the periodic switching cycle has a second frequency that is higher than the first frequency.

In another embodiment, a multicarrier beat width balance pulse width modulation method is configured with the controller to reduce leakage current in a transformer less cascaded multilevel inverter.

In another embodiment, the high move forward voltage level is accomplished by the charging and releasing course of the SC.

In another embodiment, the pressure voltage of the switches doesn’t surpass the applied voltage and the complete standing voltage of the inverter is enormously decreased without H-spans.

In another embodiment, the controller is configured to deliver a thirteen-level sinusoidal current with OK all out symphonious bending (THD) at various burdens, low PIV, TSV, high ability to help, and self-offsetting of capacitors with less detached parts, wherein to incorporate 13-level result voltage, the stage attitude PWM procedure is executed by contrasting 20/21 kHz transporter wave and 50/51 Hz reference recurrence.

In another embodiment, the switches are configured to endure the voltage during the turn-on and switch off processes and the exchanging pressure across each switch is equivalent to applied input DC preferably selected as 50V.

“Electric Vehicle Hybrid Charging System” is an exchanged capacitor (SC) based high move forward staggered inverter is developed with self-adjusting ability. The SC inverter geography is to move forward the high result voltage from the extremely low information voltage with no cumbersome transformer. This inverter creates single-stage AC voltage with a recurrence of 50 Hz from an extremely low DC input voltage of 50 V with any halfway DC transformation stage. Consequently, the SC inverter is profoundly appropriate for energy unit, photovoltaic (PV) applications, and shunt dynamic power channel (SAPF). To control the SC inverter, a multicarrier beat width balance (PWM) method is taken part in the inverter. The high move forward voltage level can be accomplished by the charging and releasing course of the SC. Besides, the pressure voltage of the switches doesn’t surpass the applied voltage and the complete standing voltage of the inverter is enormously decreased without H-spans. The relative examination of the SC inverter is made for the parts, top converse voltage (PIV), complete standing voltage (TSV), supporting skill, and voltage adjusting of capacitors. The principal subject of the paper is delivering a thirteen-level sinusoidal current with OK all out symphonious bending (THD) at various burdens, low PIV, TSV, high ability to help, and self-offsetting of capacitors with less detached parts. The entire framework is inspected by utilizing MATLAB/Simulink. The high move forward thirteen levels SC inverter is carried out in MATLAB/SIMULINK. They can endure the voltage of information source VDC. The result voltage of the inverter is multiple times the applied info voltage, which might get from the PV, energy unit and battery, and others. To incorporate 13-level result voltage, the stage attitude PWM procedure is executed by contrasting 20/21 kHz transporter wave and 50/51 Hz reference recurrence. The switches can endure the voltage during the turn-on and switch off processes. Also, the exchanging pressure across each switch is equivalent to applied input DC (50 V).

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. An electric vehicle hybrid charging system, the system comprises:
first bank and a second bank of series connected switches a interconnected in between an input voltage terminal and a reference voltage terminal in a series connection;
a plurality of switched capacitors (SCs) having a first terminal interconnected between two adjacent switches of the first bank and a second capacitor terminal interconnected between two adjacent switches of the second bank; and
a controller having a first frequency by controlling the plurality of switch pairs such that each switch pair is switched at staggered times relating to other plurality of switch pairs during a periodic switching cycle, wherein each switch pair consists of a switch from the first bank and a switch from the second bank, and the periodic switching cycle has a second frequency that is higher than the first frequency.

2. The system as claimed in claim 1, wherein a multicarrier beat width balance pulse width modulation method is configured with the controller to reduce leakage current in a transformerless cascaded multilevel inverter.

3. The system as claimed in claim 1, wherein the high move forward voltage level is accomplished by the charging and releasing course of the SC.

4. The system as claimed in claim 1, wherein the pressure voltage of the switches doesn’t surpass the applied voltage and the complete standing voltage of the inverter is enormously decreased without H-spans.

5. The system as claimed in claim 1, wherein the controller is configured to deliver a thirteen-level sinusoidal current with OK all out symphonious bending (THD) at various burdens, low PIV, TSV, high ability to help, and self-offsetting of capacitors with less detached parts, wherein to incorporate 13-level result voltage, the stage attitude PWM procedure is executed by contrasting 20/21 kHz transporter wave and 50/51 Hz reference recurrence.

6. The system as claimed in claim 1, wherein the switches are configured to endure the voltage during the turn-on and switch off processes and the exchanging pressure across each switch is equivalent to applied input DC preferably selected as 50 V.
